(19) United States
(12) Patent Application Publication
(10) Pub. No.: US 2025/0019254 A1
(43) Pub. Date: Jan. 16, 2025

(54) ADSORPTION OF CARBON DIOXIDE FROM NATURAL GAS INTO CAUSTIC AND PRECIPITATION AS CALCIUM CARBONATE AND METHODS THEREOF

(71) Applicant: Ripcord Energy Solutions, LLC, Savannah, GA (US)

(72) Inventors: Linda Esther Schweitzer, Rochester Hills, MI (US); Bobby Burkes, Sr., New Orleans, LA (US)

(73) Assignee: Ripcord Energy Solutions, LLC, Savannah, GA (US)

(21) Appl. No.: 18/768,572

(22) Filed: Jul. 10, 2024

Related U.S. Application Data
(60) Provisional application No. 63/513,595, filed on Jul. 14, 2023.

(51) Int. Cl. C01F 11/18; B01D 19/00

(52) U.S. Cl. CPC C01F 11/181; B01D 19/0073; C01F 11/183; B01D 2251/404; B01D 2257/504

(57) ABSTRACT

Methods of precipitating carbon dioxide stripped from natural gas or a post-combustion source are disclosed herein. The methods include provision of an aqueous spent caustic solution comprising carbon dioxide and adding a source of calcium ions to precipitate calcium carbonate and form a brine solution. The source of calcium ions is primarily calcium chloride and has calcium hydroxide as less than 1% wt/wt of the source of calcium ions. The method can include collecting the calcium carbonate precipitate, washing the calcium carbonate precipitate, and drying the calcium carbonate precipitate.

### RELATED APPLICATIONS

The present application claims the benefit of U.S. Provisional Application No. 63/513,595, filed Jul. 14, 2023, the entirety of which is incorporated herein by reference.

### TECHNICAL FIELD

The present application relates to the removal of carbon dioxide from natural gas, more particularly, to adsorption of the carbon dioxide into a caustic solution from which the carbon dioxide is precipitated in the form of calcium carbonate by a chemical reaction utilizing calcium chloride.

### BACKGROUND

Caustic solutions have been used in the past for scrubbing acid gases from various gas streams such as at a natural gas well or in biogas production. Typically, the solutions would contain greater than 50% water with the pH being greater than 10.0 but usually in a pH range of 10-12. When caustic solutions are more concentrated, i.e., have a pH greater than 12, they are of higher viscosity, generate foam which then forms scale (residue of chemical concentrate) in the headspace of the tower. Challenges persist, however, such as high cost, solids formation, foaming, and slippage of toxic H₂S gas (i.e., the outgoing methane gas still contains measurable hydrogen sulfide). Earlier designs maximized H₂S removal while minimizing CO₂ removal, but carbon mitigation interests now call for an interest in removing both the H₂S and CO₂.

The more water the caustic solution contains, the less cost-effective it is. More water means larger shipping cost due to the volume thereof and more solution for disposal. Furthermore, more water means reduced “atom economy” for the reaction due to dilution. The initial reaction of H₂S is with OH¹⁻ from the alkaline base to form sodium sulfide which is largely soluble as follows:

H₂S+NaOH→NaHS_{(aq)}+H₂O,

NaHS_{(aq)}+NaOH→Na₂S_{(aq)}+H₂O

In view of the problems above, the industry shifted to and currently favors amine towers as a cheaper alternative to caustic scrubbers. However, amine towers suffer from problems also. One significant problem with amine tower is the susceptibility to plugging of the tower (i.e., with use of triazine), sometimes referred to as cementation. If the tower becomes plugged, the system must be shut down to clean the tower. The lost productivity and the cleaning costs can be significant. This method also involves high disposal costs and a potential risk of toxic exposure to the amines and the waste products.

The presence of carbon dioxide (CO₂) in the gas stream will also react with the caustic solution as follows:

CO_{2(g)}+NaOH_{(aq)}→NaHCO_{3(aq)}+H₂O, and

NaHCO_{3(aq)}+NaOH→Na₂CO_{3(aq)}+H₂O.

The reaction of sodium hydroxide with sulfides is favored over the reaction with carbon dioxide. Therefore, some CO₂ can “slip” through the caustic solution with the natural gas. Traditional caustic scrubbing solutions sought to reduce the uptake of CO₂ by keeping the pH around 10-11 because a higher pH (above the pKa2 of carbonate which is 10.3) will favor uptake of CO₂.

Also, metals that react with carbonate are known to form solids. However, the reaction products above include water which means that as carbonates form, the water content also increases, helping to keep those solids in solution to some extent. The addition of chelating agent, EDTA, can reduce solid formation, but adds to viscosity of the solution. Increased viscosity is bad for bubble formation.

U.S. Pat. No. 8,741,244 discloses a carbon capture process whereby carbon dioxide is absorbed into a hydroxide solution (e.g., NaOH, Ca(OH)₂, KOH) and resulting salts are separated or precipitated out of solution. There are several embodiments mentioned for separating components, but none of the methods include adding a chloride salt in a precipitation reaction to isolate carbonates. Moreover, the '244 patent, JPS5969425A, and WO/2013/157912 suggest the use of caustic/hydroxide solutions as dilute concentrations, forming either primarily bicarbonate, about a 50/50 bicarbonate/carbonate mixture, or the use of solid beds of alkali-metals. Dilute solutions require more than one tower of stripping solution due to high bleed of carbon dioxide through the solution. The requirement for more water also adds to shipping costs and volume of product to treat or dispose.

JPS5969425A does not introduce calcium chloride to precipitate calcium carbonate nor is the process directed to carbon capture; rather, hydrated lime (calcium hydroxide) or calcium oxide (water solubility 1 g/840 mL at 25° C.) is used to precipitate calcium carbonate from caustic solutions that have adsorbed carbon dioxide. Lime, however, has a low water solubility (1.89 g/L at 20° C.) and results in unreacted calcium solids that have to be further purified from the carbonate precipitant and a water waste with a pH higher than circumneutral.

Generally, when caustic (NaOH) is used to collect and concentrate carbon dioxide from various gases, NaOH is used at concentrations less than or equal to 5 molar (5M), and more often around 1M, in which case more than one tower is needed due to CO₂ slippage (i.e., low efficiency of carbon capture). When a dilute caustic solution of NaOH is used for the purpose of CO₂ absorption, the more water used, the higher the cost of shipping/transportation. Furthermore, using a more dilute solution creates more product requirement which lead to more towers and other infrastructural needs, and creates a larger volume of spent product. Also, a more dilute solution will result in a lower yield of precipitated carbonate or bicarbonate. If the NaOH is too concentrated, it forms a solid when reacted with high concentrations of CO₂.

While these methods have been shown to absorb or “capture” carbon, there is always a need to find a more cost effective, more efficient, more environmentally friendly process that also produces useful end products.

### SUMMARY

In all aspects, methods of precipitating carbon dioxide stripped from a gas source, such as natural gas or post-combustion sources, are disclosed herein. The method includes providing an aqueous spent caustic solution comprising carbon dioxide and adding calcium chloride and calcium hydroxide to precipitate calcium carbonate and to form a brine solution. The brine solution will be circumneutral. The circumneutral brine solution can be used for enhanced oil recovery (also called tertiary recovery of oil). For enhanced oil recovery, the circumneutral brine solution should be diluted with water to a desired salinity.

The addition of calcium chloride includes determining the molar concentration of the caustic solution and introducing half as much calcium chloride and having the calcium hydroxide as about 0.2% to about 0.8% of the total calcium concentration, more preferably about 0.3% to about 0.6% and even more preferably about 0.3% to about 0.5% of the total calcium concentration. The method can also include adding water before adding the calcium chloride and calcium hydroxide in an amount sufficient to solubilize precipitated sodium carbonate if present in the aqueous caustic solution. The aqueous spent caustic solution should have a pH in a range of 10.3 to 11.5, more preferably 11.0 to 11.5.

The method can include collecting the calcium carbonate precipitate, washing the calcium carbonate precipitate, drying the calcium carbonate precipitate. Likewise, the method can include collecting the brine solution, removing volatile organic compounds therefrom, and optionally, applying the brine solution to a roadway or diluting with water to produce a ten pound brine product or other desired salinity for enhanced oil recovery such as low salinity waterflooding.

In all aspects, the method can include providing a caustic treatment composition having a density that is less than 1.5 g/ml and a pH greater than 11.5 and comprising:
about 25% to about 33% wt/wt of a strong base;
less than 0.1% wt/wt chelating agent; and
balance water;
   and sparging a source gas comprising carbon dioxide through the caustic treatment composition to form an aqueous spent caustic solution comprising carbon dioxide. This carbon dioxide is precipitated as calcium carbonate as described above and, in more detail, herein. When sparging, the pH is monitored and is allowed to drop to 11.5.

The strong base is typically sodium hydroxide and/or potassium hydroxide, more preferably a mixture thereof. When the strong base is a mixture of sodium hydroxide and potassium hydroxide, it can have a ratio of weight percent of about 1:1.

The chelating agent can be ethylenediaminetetraacetic acid or ethylenediamine present as less than 0.05% wt/wt of the caustic treatment composition. The chelating agent can also include a natural chelating agent, such as grape seed extract. The grape seed extract can be present as less than 0.005% wt/wt of the caustic treatment composition.

### BRIEF DESCRIPTION OF THE DRAWINGS

FIG. 1 is a photograph of flow natural gas through concentrated caustic solution of density 1.5 g/ml without glycol and without using a diffuser or sparger.

FIG. 2 is a photograph of flow air bubbles into the caustic solution without polyethylene glycol.

FIG. 3 is a photograph of flow of air bubbles into the caustic solution comprising polyethylene glycol, which has visibly reduced bubble size.

FIG. 4 is a schematic illustration of a caustic scrubber having a packed bed in the tower.

### DETAILED DESCRIPTION

The following detailed description will illustrate the general principles of the invention, examples of which are additionally provided in the accompanying drawings.

As used herein, percent or the percent symbol, is understood to mean a percent by weight of the total composition unless expressly stated otherwise. It should also be noted that in specifying any range of concentration or amount, any particular upper concentration or amount can be associated with any particular lower concentration or amount disclosed herein.

Except in the working examples, or where otherwise explicitly indicated, all numbers in this description indicating amounts, parts, percentages, ratios, proportions of material, physical properties of material, and conditions of reaction are to be understood as modified by the word “about.” “About” as used herein means that a value is preferably +/−5% or more preferably +/−2%.

As used herein, “room temperature” means 25° C.+/−5° C., more preferably +/−2° C.

As used herein, “circumneutral” means a pH level that is close to neutral, typically around 5.5 to 7.5, more preferably, 6.5 to 7.5.

In a first aspect, treatment compositions for natural gas or biogas that convert hydrogen sulfide compounds to water soluble sulfides and convert carbon dioxide to water soluble carbonates and/or bicarbonates. The treatment composition includes as a weight percent of the composition:
(a) a strong base;
(b) 0.05 to 0.025% wt/wt polyethylene or polypropylene glycol; and
(c) 0.005 to 0.02% wt/wt ethylenediaminetetraacetic acid (EDTA) and/or ethylenediamine (EDA); and
(d) balance water;
wherein the caustic treatment composition has a pH greater than 12.
   The treatment composition has a pH that is 12 or greater, more preferably 13 or greater. The pH is controlled by the strong base. The strong base can be NaOH and/or KOH. In one embodiment, the strong base is a mixture of NaOH and KOH in about a 1:1 ratio by volume. For example, NaOH is commercially available in its concentrated form as 50% wt/wt in water and KOH is commercially available in its concentrated form as 45% wt/wt in water, and a blend thereof at a ratio of 1:1 would be a mixture of 100 ml concentrated NaOH to 100 ml of concentrated KOH, or 1 L to 1 L, etc. In another embodiment, the ratio is 1.1:1, or more preferably 1.09:1. In yet another embodiment, the ratio is 1.5:1, 2:1, or 3:1. The ratio is typically selected to balance overall properties of the treatment solution, including, but not limited to viscosity, density, and a balance of cation concentrations for enhanced solubility of end products.

In one embodiment, the treatment composition has a pH of 13 and includes as a weight percent of the composition:
(a) a blend of NaOH and KOH;
(b) 0.025% wt/wt polyethylene glycol;
(c) 0.01% wt/wt EDTA; and
(d) balance water.
   The caustic blend of KOH/NaOH (˜50% water), 0.01% wt/wt EDTA, 0.025% wt/wt PEG, and 0.075% H₂O received a B++ rating in a corrosion test conducted by a commercial lab.

In another embodiment, the treatment composition has a pH of 13 and includes as a weight percent of the composition:
(a) a blend of NaOH and KOH;
(b) 0.025% wt/wt polyethylene glycol;
(c) 0.01% wt/wt EDA; and
(d) balance water.

In all embodiments, for better blending with the strong base(es), the EDTA and/or EDA is added to the PEG, which is mixed with a portion of the water. This aqueous mixture is then added to the strong base(es).

In all embodiments, the strong base can be a mixture of NaOH and KOH. In one embodiment, the NaOH is about 22% wt/wt and the KOH is about 20% wt/wt of the aqueous treatment composition.

Our experiments revealed that the density of the treatment solution is a factor that effects how the gas, i.e., natural gas or biogas, disperses through the treatment solution. A density equal to or greater than 1.5 g/ml is too high because the gas does not disperse effectively into the treatment solution and tends to move as a slug flow or heterogenous flow regime, which resulted in hydrogen sulfide gas bleeding or slipping through the treatment solution without treatment. A homogeneous flow regime is much more desirable, especially one with tiny bubbles distributed over the full internal cross-section of a caustic scrubbing tower. The bubbles have diameters that are smaller than 1 cm, and preferably less than 0.5 cm, more preferably less than 2 mm. Interestingly, when a small amount of polyethylene glycol was added to the caustic treatment solution, also referred to as a stripping solution, the same gas did not have H₂S slippage and small bubbles were homogenously dispersed into the stripping solution rather than moving through the column in a slug flow. Bubble tower designs also aid in the dispersion of gas into the stripping solution. Examples include the addition of a sparge stone, a diffuser, and/or a static mixer.

One of the problems discussed in the background herein is the formation of scaling and the presence of foam. The treatment solutions disclosed herein include a viscosity reducer (the polyethylene or polypropylene glycol) and a stabilizer for reducing the precipitation of metal sulfides, metal carbonates, and metal hydroxides (EDTA or EDA). The experiments evidenced that the viscosity reducer and stabilizer work together to reduce scaling and foaming during the stripping process. EDA has some capacity to scavenge hydrogen sulfide, up to seven H₂S molecules per molecule of EDA. At high pH and high sulfur concentration, aided by the EDTA or EDA, polysulfides formed:

[HS⁻]+[H₂S]ₙ₋₁→[H₂S—S—H]⁻ₙ

In the absence of oxygen and at room temperature, polysulfides are extremely stable at pH 14, and can be converted to other sulfur species upon oxidation or heating.

After a natural gas sample was treated with one of the treatment solutions disclosed herein, a polysulfide solution of pH 13 and 100 ppm EDTA with a concentration of 3.7% total sulfur measured by XRF did not decrease after one year in the refrigerator even with headspace in the bottle and the bottle was opened at least ten times during that period. If the polysulfides had broken down, hydrogen sulfide would escape from the solution and the concentration would have decreased. Experiments related hereto are presented below in the working example section.

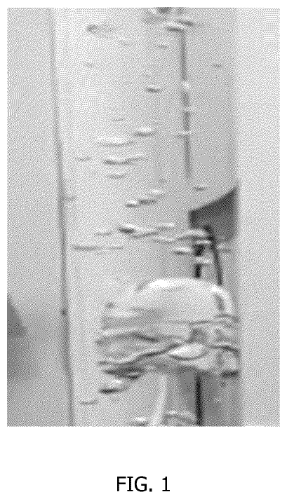

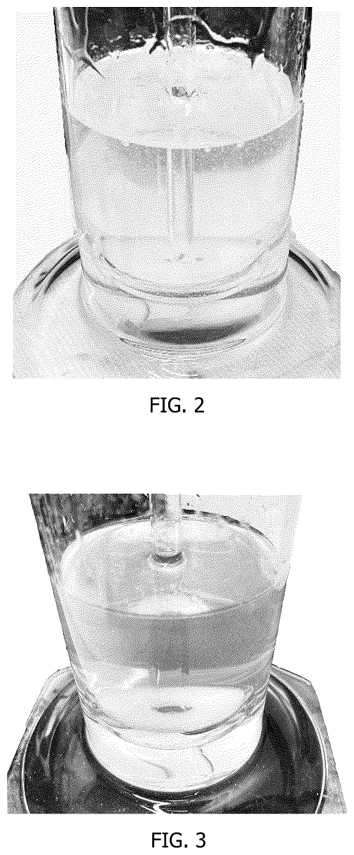

Referring now to FIG. 1, a caustic solution of pH 13 containing 0.01% wt/wt EDTA but no PEG was tested in a glass cylinder by running air into the solution until heterogenous gas flow was achieved. Heterogenous gas flow was achieved with caustic solution of density 1.45 g/mL, but with some bubbles rising quickly to the surface without making contact rather the first diffusing into the solution. This solution was run under the same conditions in the same glass cylinder as discussed above for FIG. 1, but with the presence of a sparge stone in each of the apparatus of FIGS. 2 and 3 and with the addition of PEG for the trial shown in FIG. 3. Smaller bubbles were produced, which provides better contact of the gas with the solution, with the presence of the sparge stone, see FIG. 2, at the entrance of the gas (air) into the solution, containing. For FIG. 3, PEG was diluted with water 1:4 and then added to the caustic solution tested with respect to FIG. 1 for a total concentration of 0.025% wt/wt PEG (final density 1.4 g/mL). As evident by comparison of FIGS. 2 and 3, the PEG reduced bubble size and provided better contact of the gas with the solution.

The treatment solutions are substantially free of or are free of organic acids such as fulvic acid and humic acid, silicates, aldehydes, and peroxygen compounds. As used herein “substantially free of” means less than 0.0001% wt/wt if present in the treatment solution.

In another aspect, methods of treating natural gas or biogas with the aqueous treatment compositions described above are included herein, more particularly a caustic scrubbing method using a wet scrubbing technique. Caustic scrubbers are commercially available, for example from SLY Inc. of Strongsville, Ohio. A wet scrubber can be an impingement plate scrubber, a Venturi scrubber, or an educator Venturi scrubber. Wet scrubbers use a liquid solvent to remove unwanted chemicals from a gas stream via chemical or physical absorption. Physical absorption occurs when the absorbed compound dissolves in the solvent and chemical absorption occurs when there is a chemical reaction between the absorbed compound and the solvent. Here, it is desirable to have the gas small bubbles in the solution and for those small bubbles to be distributed homogenously throughout.

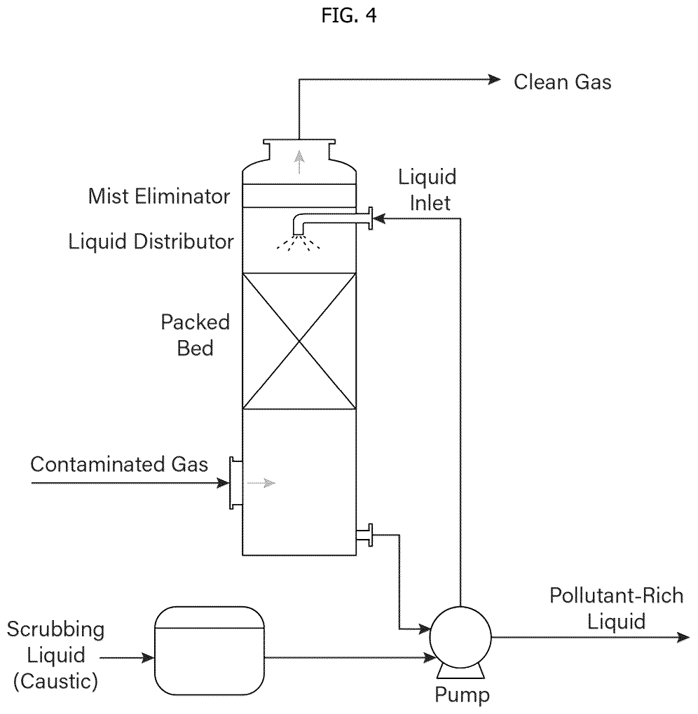

Some wet scrubbers include a packed-bed counterflow scrubber as shown in FIG. 4. In this system, the contaminated gas stream is fed to the bottom of the tower and the solvent is fed to a liquid distributor at the top of the tower. The liquid flows down the column over the packing and the gas flows up the column. The gas-liquid contact in a packed column is continuous, and column performance relies heavily on maintaining good liquid and gas distribution throughout the packed bed. At the top of the packing, mist eliminators or demisters can be used to capture liquid droplets.

A natural gas or a biogas in need of a reduced content of one or more of sulfur compounds, acid gas, and carbon dioxide is provided. The aqueous treatment composition is provided. The natural gas or biogas is introduced into a caustic scrubber containing one of the treatment solutions disclosed herein at a feed rate in a range suitable for the size of the caustic scrubber. A commercial caustic scrubber may have a feet rate of 10,000 standard cubic feet per day up to 100 MSCFD.

Post-treatment, the polysulfides can be converted to other sulfur species via oxidation and/or heating using methods. Here, spent caustic scrubbing solution containing percent levels of sulfide were treated with aqueous hydrogen peroxide, which had a concentration less than or equal to 10% wt/wt. Higher concentrations of peroxide are too exothermic to safely control. The starting pH of the spent solutions were 11-13, but adding peroxide beneficially reduces the pH. When all sulfides were oxidized completely to sulfate ions in solution, the pH dropped and stabilized to within 8-9. The energy released by the reaction can be controlled by slow addition of pre-diluted spent caustic solution into aqueous hydrogen peroxide. The aqueous hydrogen peroxide has a concentration in a range of 1% to 10% wt/wt. The dilution of the spent caustic solution to water is in a ratio range of 1:2 up to 1:10. The ratio of peroxide to sulfur can be controlled via the dilutions of the spent caustic treatment solution and/or the concentration of the hydrogen peroxide. For a reasonably fast reaction, the ratio of peroxide to sulfur is 2.5:1. As used herein, a “fast” reaction is one that has a half-life that is less than 30 minutes. When the ratio of peroxide to sulfur is 2.5:1 for the examples tested herein, the half-life was less than 15 minutes. When the spent caustic sulfide solution was oxidized with hydrogen peroxide, no precipitants formed, and the water was colorless. All the sulfide oxidized to sulfate ions in solution.

A hydrogen peroxide generator (e.g., such as commercially available from HPNow of Denmark under the brand name HPGen) could be used as the source of hydrogen peroxide. Such generators only require air and water. This is a much greener approach than water treatment because no transportation of chemicals by boat, train, or truck are required. The generator can be set to a desired hydrogen peroxide concentration, thereby eliminating the need to perform dilutions.

### WORKING EXAMPLES

### Effect of EDTA on the Stability of Polysulfides

A stock solution of polysulfides [generated by running hydrogen sulfide through the caustic stripping solution] was diluted with distilled water and compared to a distilled water sample containing 100 ppm EDTA. Then, the samples were acidified and re-tested. The percentage of sulfides in solution were measured by the Hach Method 8131. The headspace H₂S was measured by Drager tube (0-200 ppm capacity tube). The measurements were made immediately. The vials were left open, and the measurements were repeated 24 hours later.

TABLE 1

| Polysulfide stock | [EDTA] | | [Sulfide] in Solution |
|---|---|---|---|
| solution | % wt/wt | Time | % wt/wt unless marked |
| diluted 1:50 with | 0.01 | T = 0 | 0.28 |
| distilled water | | T = 24 hr | 0.24 |
| | 0 | T = 0 | 0.25 |
| | | T = 24 hr | 0.23 |
| diluted 1:500 with | 0.01 | T = 0 | 0.034 |
| distilled water | | T = 24 hr | 0.013 |
| | 0 | T = 0 | 0.033 |
| | | T = 24 hr | 0.12 |
| diluted 1:50 with | 0.01 | T = 0 | 0.29 |
| distilled water | | T = 24 hr | 125 ppm |
| and acidified to | 0 | T = 0 | 0.27 |
| pH 7 with 6N HCl | | T = 24 hr | 250 ppm |

When EDTA was not placed in solution, upon acidification, hydrogen sulfide gas immediately begins to escape the solution as shown by lower concentration numbers (less sulfide is retained in solution) as well as increase in H₂S gas in headspace of container. Upon dilution, the sulfide is stable at higher pH and higher sulfide concentration, but losses occur when further diluted. These data elucidate further stabilization of polysulfides (at moderate concentration) by EDTA by nonbonded interaction.

### Effect of PEG on the Density Viscosity and Surface Tension

Samples of caustic solution with and without (PEG) and addition of water were evaluated to demonstrate the physical properties of density, viscosity and surface tension of the stripping solution relative to gas holdup. Density was measured by taking the average of three measurements of the weight of one milliliter of solution. Viscosity was measured with a viscometer (NDJ-1, China) according to manufacturer's instructions. Surface tension was measured three times with a tensiometer (Duran Wheaton Kimble) and the numerical value in Table 2 are the mean thereof.

TABLE 2

| Caustic Blend KOH/NaOH | | | | | |
|---|---|---|---|---|---|
| (~50% water) | | | Density | | Surface |
| [EDTA] | [PEG] | [Water] | (g/mL) | Viscosity | Tension |
| % wt/wt | % wt/wt | % wt/wt | at 23° C. | (mPa · S) | (N/m) |
| 0.01 | 0 | 0 | 1.45 | 52 | 195.5 |
| 0.01 | 0.025 | 0.075 | 1.40 | 40 | 178.5 |
| 0.01 | 0 | 0.1 | 1.44 | 46 | 180.1 |

PEG reduced the density, the viscosity and the surface tension.

### Effect of PEG on Foam Reduction

Foaming as a function of PEG concentration in 20 mL of the treatment solution (48% wt/wt strong base, 0.01% wt/wt EDTA, variable PEG, and balance water) with an air purge rate of 250 mL/min were evaluated. The height of solution in the tube was 3.75 inches.

TABLE 3

| | Foam | Foam |
|---|---|---|
| [PEG] | Height | Settling |
| (% wt/wt) | (inches) | (sec) |
| 0 | 5.5 | 50 |
| 0.001 | 5.5 | 50 |
| 0.005 | trace | 1 |
| 0.01 | none | — |
| 0.05 | none* | — |

*Solution is pushing up sides of flask but not foaming.

A small amount of PEG reduced the density, viscosity, surface tension as compared to adding the same volume of water. Moreover, the PEG reduced foaming when purged with air.

### Example 1: Natural Gas Run

A natural gas sample was run through a stripping solution containing 0.005% wt/wt PEG. Key performance indicator (KPI) is how long the solution lasts before break-through of acid gases. Once a total acid gas (CO₂+H₂S) reached 5% wt/wt, this was considered the threshold time for how long the chemistry lasted before breaching pipeline specification. The natural gas sample was tested for initial presence of CO₂ and H₂S, which was measured as a combined total of 18% by weight of the sample. The balance of the natural gas sample comprised methane and other hydrocarbon gases. The pounds of sulfur removed per gallon was calculated. Observations of foaming and solids formation were recorded.

### Experiment Setup

Apparatus setup: 1½″ flow meter retrofitted with ¾″ sparge stone.
Chemistry Volume: 190 ML of neat product filled inside the miniature contact unit.
Natural Gas Initial: 12% wt/wt H₂S, 6% wt/wt CO₂.
Natural Gas feed rate: 10 liters per minute

Once solids were observed, the sparging continued for 25% over the KPI time frame breach to intentionally overspend the product to see if more solids form beyond the KPI breach. This is an important test that simulates under treating, which in real world scenarios happens all the time. Solids Evaluation: Product was drained at the end and the amount of solids was documented; freshwater was used as a diluent to understand what % wt/wt of those solids are water soluble.

Foam Evaluation: <2× the liquid bed height to judge foam control. This is mainly for vertical vessel type applications where you assume that your liquid height is ⅓ of the vessel volume, ⅔ open space for foam dissipation.

Testing Equipment: H₂S and CO₂ tubes were pulled every 5 minutes for the first 120 minutes, and then every 2 minutes after that. Standard tubes utilize a Honeywell pump style puller with standard tube measurements.

Results: The run times fell between 150-180 minutes with sulfur scrubbing limits in the range of 11-13 lbs. per gallon. Some solids formed but were 100% water soluble. There was zero slippage of H₂S at the beginning of the runs. Foaming was reduced 50% by adding PEG to the stripping solution based on height of foam in the contact vessel. Scaling was observed only at the top where foaming left a thin film on the walls of the vessel. Thus, reduction of foaming is crucial to reducing scaling.

### Example 2: Scale-Up

A gas well with natural gas containing 130,000 ppm H₂S and 40,000 CO₂. Gas flow was 250 mL/min. Twenty milliliters of the caustic solution diluted with 50% water was put into a gas tube. In the first 53 minutes, the H₂S coming through the solution was below 10 ppm. After one hour, the H₂S bled through to 30 ppm. CO₂ was <500 ppm (almost ambient levels). There was slight foaming which was manageable. When H₂S slippage began, the spent solution had a pH of 11.5. Significant breakthrough occurred when the pH went below 10.5. The amount of sulfur removed yielded a result of 5.9 lbs/gal. This result of diluting the caustic solution 1:2 with water is consistent with the stoichiometry in that the result is about half that of the full-strength the caustic solution. H₂S levels in the treated natural gas coming out of the stripping solution was below 10 ppm during the run and carbon dioxide was <500 ppm. The caustic solution was a blend of NaOH and KOH; 0.025% wt/wt polyethylene glycol; 0.01% EDTA; and balance water.

### Example 3: Injection of Product Into Gas/Oil/Water Sample

A natural gas sample had oil added to it to achieve a Gas-Oil-Ratio of 100,000 in a 500 ml Tedlar Bag and 0.1 mL water was added to the bag. The gas phase had 0.1% H₂S. To this bag, the caustic blend of KOH/NaOH (˜50% wt/wt water), 0.01% wt/wt EDTA, 0.025% wt/wt polyethylene glycol, and 0.075% wt/wt H₂O was added at 0.1% volume relative to the volume of natural gas oil mixture present (i.e., 0.5 ml was added to the 500 ml sample). A Drager tube of 200 ppm was poked into the bag and sample was drawn up. The tube did not detect H₂S in the gas phase.

After any of the above treatment solutions have been used in a caustic scrubber to remove hydrogen sulfide form a gas source, the spent solution is collected. Such spent solutions typically require handling as a waste product. Here, the spent solution can be treated to oxidize the soluble sulfides into sulfates.

### Example 4: Oxidation of Aqueous Sulfides Using Hydrogen Peroxide

Samples of spent caustic treatment solution contained 12% total sulfur in the form of polysulfides. The spent solutions were produced at a gas well whereupon the gas was bubbled through the caustic treatment solution in order to clean the gas of hydrogen sulfide (H₂S). The natural gas contained 13% H₂S and 4% CO₂ impurities. The gas was fed through 200 mL of solution in a miniature contactor at a rate of 250 ml/min until the H₂S coming through went to 30 ppm (initially, it was 0-2 ppm H₂S “slipping” through the solution). Two runs were completed. The spent solution was capped and stored refrigerated until used for the following experiments.

The spent caustic scrubbing solutions had a pH between 11 and 13. The solutions contained polysulfides, bisulfide ions (HS—) and to a lesser degree sulfide ions (S²⁻). At such a high concentration (percent levels total sulfur), even though the speciation favors bisulfide and sulfide ions compared to hydrogen sulfide, a measurable amount of H₂S is present in the headspace of the solution. Acidification with a strong acid or hydrogen peroxide protonates the bisulfide to H₂S, but also oxidizes the sulfide.

The oxidation state of sulfur in H₂S, HS⁻ and S²⁻ is −2. There is an 8 electron oxidation from sulfide to sulfate with a wide variety of intermediates such as elemental sulfur, polysulfides, thiosulfate, polythionates, and sulfite. The theoretical heat of reaction (H₂S+H₂O₂) is 225 kcal/gm-mol of sulfate or 12,700 Btu evolved per pound of sulfur. Oxidation needs to be controlled to dissipate heat and/or slow addition of chemicals and monitoring of heat of solution. The proposed reactions in the presence of excess hydrogen peroxide for all sulfur to be oxidized to sulfate are:

HS¹⁻+H₂O₂→HSOH+OH⁻

HSOH+HSₓ₋₁¹⁻→HSₓ¹⁻+H₂O(x=2-9) potential polysulfide formed

HSOH+2 H₂O₂+2OH¹⁻→SO₃²⁻+4H₂O

HSₓ¹⁻+(2x+1)H₂O₂+(2x−1)OH¹⁻→xSO₃²⁻+(3x+1)H₂O

(x−1)SO₃²⁻+HSₓO¹⁻→(x−1)S₂O₃²⁻+HS⁻

(z/2)S₂O₃²⁻+(5−z)H₂O₂→S_{z}O₆²⁻+(6−3z/2)H₂O+(z−2)OH¹⁻(z=3,4)

SO₃²⁻(sulfite)+H₂O₂→SO₄²⁻(sulfate)+H₂O

S₂O₃²⁻(thiosulfate)+H₂O₂+2OH¹⁻→2SO₄²⁻+5H₂O

S_{z}O₆²⁻+(3z−5)H₂O₂+(2z−2)OH¹⁻→zSO₄²⁻+(4z−6)H₂O

A small addition of H₂O₂ converts sulfides to zero-valent sulfur compounds (S⁰). At high concentrations of zero valent sulfur (ZVS), long polysulfide chain lengths form under alkaline conditions of pH>7.5. At lower pH, there is a greater likelihood of particulate ZVS (i.e., elemental sulfur). The oxidation of sulfides and polysulfides in solution depends on conditions such as pH, sulfide/oxygen ratio, and presence of catalysts.

When the spent caustic solution was added to water and treated incrementally with H₂O₂, the solution turned from a gold color to colorless and then back to a bright yellow/orange color before turning colorless again. The color shift is characteristic of polysulfide formation. Addition of excess peroxide completely oxidized all sulfur to sulfate, confirmed by monitoring with a Hach spectrophotometer using Hach methods 8131, 10308, and 10248, respectively for sulfide, sulfite and sulfate. Aliquots had to be diluted before analyzing to get into the range of quantification.

Use of copper as a catalyst on the polysulfide spent caustic solution created color, or solids, or left unacceptable residual copper in solution after treatment. Iron at 1 ppm worked as a catalyst but requires addition of chemical, in this case iron chloride. No chemical is needed if a hydrogen peroxide generator can be employed. Hydrogen peroxide alone in excess can oxidize all sulfides without creating a precipitant or color or metal residuals in solution. The waste product will only be a high sulfate concentration water. Sulfate can then be precipitated out with lime (as gypsum) or removed with membranes. Alternatively, a biological method can be used to generate elemental sulfur. When minimal water and peroxide are used in the oxidation process, the volume of solution will be 3-5 times that of the initial waste stream.

TABLE 4
Treatments of spent caustic solution containing
sulfur in the form of sulfides

| | Dilute | | Sulfide in water |
|---|---|---|---|
| Sample Initial | water: | Chemicals | (ppm) & reaction |
| Total [Sulfur] | sample | added | time (min) |
| 12% | 3:1 | 1% H₂O₂ | Over range after 30 |
| 12% | 3:1 | 0.0001% FeCl | Over range after 30 |
| | | 1% H₂O₂ | |
| 12% | 3:1 | 0.0005% FeCl | Nondetect @ 30 |
| | | 1% H₂O₂ | |
| 12% | 7:1 | 2.25% H₂O₂ | Nondetect @ 30 |
| 12% | 5:1 | 6% H₂O₂ | Nondetect @ 10 |

The last row shows that a starting solution of 12% total sulfur in the form of sulfides/polysulfides was diluted in the treatment process with the addition of water and peroxide, the peroxide having a 6% concentration, which gives a peroxide to sulfur ratio of 2.5:1. The previous row requires a lot of water in the dilution starting with a 3% peroxide solution which an efficiency ratio of 1.3:1 of peroxide to sulfide. The last treatment was repeated; in one sample, the peroxide was added to the polysulfide solution, and in the next sample, the polysulfide solution was added to aqueous peroxide. With no catalyst, excess peroxide oxidizes all sulfides were oxidized, no precipitants were formed, the solution was clear and colorless, and the pH was 8. The water was analyzed for sulfate and found to be over-range for sulfate and after diluting 1000 times, the concentration is in the same order of magnitude as the starting sulfide solution.

If there are any remaining organic constituents in the solution, organic carbon can be mineralized with the use of iron (III) or by filtering the water through activated carbon.

After the adsorption of the carbon dioxide from the natural gas into a caustic solution as described above and below, the carbon dioxide is precipitated as a calcium carbonate according to the following equations:

2NaOH+2KOH_{(aq)}+CO_{2(g)}→Na₂CO₃+K₂CO_{3(aq)}+H₂O

Na₂CO₃+K₂CO_{3(aq)}+CaCl₂+Ca(OH)₂→CaCO₃₍ₛ₎+2NaCl_{(aq)}+2KCl_{(aq)}

The reaction of carbon dioxide with the hydroxide(s) generates a brine solution comprising carbonate salts, so it is counterintuitive to be adding more salt to the mixture, but the sum total of products is commercially worth more than the reactants. The addition of the calcium chloride yields a calcium carbonate precipitant plus a brine solution having a pH in a range of 5.5 to 7.5, more preferably about 6.0, which is favorable for advanced oil recovery or for creating a road salt solution.

Methods disclosed herein include providing a caustic treatment composition having a density that is less than 1.5 g/ml and a pH greater than 11.5 that includes
about 25% to about 33% wt/wt of a strong base;
less than 0.1% wt/wt chelating agent; and
balance water;
   and sparging a source gas comprising carbon dioxide through the caustic treatment composition to form an aqueous spent caustic solution comprising carbon dioxide. This carbon dioxide is precipitated as calcium carbonate per the reaction scheme above. When sparging, the pH is monitored and is allowed to drop to 11.5.

Carbon dioxide is stripped out of natural gas or other combustion sources into an aqueous caustic solution containing sodium and/or potassium hydroxide (NaOH/KOH) at a concentration of 25-33% (wt/wt) and <1% chelating agents. Other combustion sources include but are not limited to flue gases from the burning of fossil fuels (e.g., coal and natural gas), waste incineration, and flared gas (e.g., burning of excess/unwanted natural gas in an oil field). The chelating agent can be ethylenediaminetetraacetic acid (EDTA) or ethylenediamine. Natural chelating agents may also be used, such as grape seed extract or polyphenolic compounds. Polyphenolic compounds include low molecular weight polyphenolic acids, specifically ones that are stable at high pH. Examples include quercetin and gallic acid. Solubility of polyphenolic compounds can be enhanced with the addition of a relatively small amount of amino acids. The ethylenediaminetetraacetic acid or ethylenediamine can be present as less than 0.05% wt/wt of the caustic treatment composition, more preferably about 0.01% wt/wt. The grape seed extract can be present as less than 0.005% wt/wt of the caustic treatment composition.

The adsorption of carbon dioxide is allowed to proceed until the pH of solution drops to 11.5 and/or carbon dioxide breakthrough occurs, thereby forming a “spent solution.” To this spent solution, calcium chloride is added to precipitate the carbon dioxide in the form of calcium carbonate. If sodium carbonate precipitate is present in the spent solution, water, in an amount sufficient to solubilize the precipitated sodium carbonate, is added before adding the calcium ions (Ca²⁺), mainly in the form of calcium chloride. The calcium ions are added at the molar ratio of carbonates captured by the adsorption process. More specifically, the addition of calcium chloride includes determining the molar concentration of the caustic solution and introducing half as much calcium chloride.

As shown by Examples 5-7 below, higher yields of calcium carbonate precipitate were achieved when a small amount of calcium hydroxide was added as part of the source of calcium ions. The calcium hydroxide aided in maintaining an alkaline pH to prevent crystallization of sodium carbonate and increase the yield of calcium carbonate precipitation. The calcium hydroxide was added as about 0.2% to about 0.8% of the total calcium concentration, more preferably about 0.3% to about 0.6% and even more preferably about 0.3% to about 0.5% of the total calcium concentration. The method can also include adding water before adding the calcium chloride and calcium hydroxide in an amount sufficient to solubilize any precipitated sodium carbonate present in the aqueous caustic solution. The aqueous spent caustic solution should have a pH in a range of 10.3 to 11.5, more preferably 11.0 to 11.5.

With reference specifically to Example 7, the use of high concentration (25%-33% wt/wt) NaOH/KOH keeps the pH well above 10.3 which is the pKa of carbonate while adsorbing carbon dioxide. This range is critical to keep the carbonate in the form carbonate ion (CO₃²⁻) and not bicarbonate ion (HCO₃⁻) and concentrations higher than 33% wt/wt were not achievable in adsorbing carbon dioxide without forming solid sodium carbonate.

Example 7 demonstrates that the addition of a chelating agent(s) makes it possible to increase the concentration of caustic solution in the carbon capture process without precipitations of metal carbonates and hydroxides occurring. The addition of <0.005% of filtered grape seed extract plus 0.01% EDTA slowed the formation of solid sodium carbonate when carbon dioxide was sparged through a concentrated NaOH solution. Also, during the sparging of CO₂ into the solution containing chelating agents, there was no CO₂ slippage (all carbon dioxide was absorbed into the solution) from the moment the gas started bubbling through the solution until the pH dropped from 14 to 11.5. Carbon dioxide, measured by Dräger tube, coming out of the sparged solution was about 0.5% at a pH of about 11.5. As the pH approached 11.0, the percentage of carbon dioxide slipping through the solution (i.e., not getting absorbed) increased to 2-4%. Going below pH 11.5 is not advisable because the carbonate equilibrium shifts from carbonate ion CO₃²⁻ to bicarbonate, HCO₃⁻. Note that the pKas of a carbonate system are 6.3 and 10.3, whereby the dominant species of carbonate at pH higher than 10.3 is the carbonate ion; the dominant species at pH between 6.3 and 10.3 is the bicarbonate; and below pH 6.3, the dominant species is carbonic acid (H₂CO₃) which liberates CO₂. An advantage of starting with a concentrated caustic solution is that CO₂ slippage does not occur.

The methods disclosed herein resulted in yields of calcium carbonate precipitate of greater than 90% of the theoretical yield. In some examples the yield was in a range of about 93% to 95% of the theoretical yield.

### Example 5: Precipitation of Calcium Carbonate

Spent solutions were stored overnight and sodium carbonate crystallized out of some of the samples. The mother liquors were slightly diluted with water to solubilize the sodium carbonate; then, calcium chloride was added to precipitate calcium carbonate. The filtrate (mother liquor) contained a high concentration of brine of pH about 6. The yields at first were low (10-12% calculated by the measurement of dried solid carbonates compared to theoretical yield from the stoichiometry of the equations) and during the process, carbon dioxide bubbled out of solution (confirmed by CO₂ Drager tube measurement) due to the drop in pH from precipitation of the carbonate. This necessitated a better process to keep the pH high long enough to get precipitation of the calcium carbonate without losing CO₂ to off-gassing. The calcium carbonate solid can be washed with cold water and/or ethanol and dried.

### Example 6: Precipitation of Calcium Carbonate With Increased pH

A caustic treatment solution containing sodium and potassium hydroxide at a concentration 28% wt/wt with a density of 1.3 g/mL with less than 0.005% of natural organic chelating agents plus 0.01% EDTA was provided. Carbon dioxide was sparged into the caustic treatment solution until the pH dropped to 11.5. Calcium chloride was added until a precipitant was seen forming; then, a small amount of calcium hydroxide was added to increase base [OH⁻] alkalinity during precipitation of calcium carbonate. In one sample, the calcium hydroxide was added at ten percent the amount of calcium chloride added; the brine product had a high pH (10-11). To another sample, the calcium hydroxide was added at 0.4% of the total calcium concentration, and the pH of the brine product was 6 and had a salinity (by refractometer measurement) of 15% (wt/wt). It was found that when at least 0.4% of the calcium added was in the form of calcium hydroxide, the yield of calcium carbonate was approximately 460 grams per liter of caustic solution. Residual calcium in a brine sample was 0.1% concentration measured by x-ray fluorescence. A sample of brine was tested for residual carbonate: one, by adding more CaCl₂/Ca(OH)₂ and seeing that no further precipitation occurred; and two, by acidification of the brine to test for release of carbon dioxide, confirmed by Drager tube. This process yields greater than 90% removal of CO₂ in the form of calcium carbonate product. The calcium carbonate solid can be washed with cold water and/or ethanol and dried.

### Example 7: Evaluation of the Caustic Concentration

A caustic treatment solution containing sodium and potassium hydroxide at a concentration 28% wt/wt with a density of 1.3 g/mL with <0.005% of natural organic chelating agents plus 0.01% EDTA was used to collect and concentrate carbon dioxide for multiple runs using 10-20 mL of solution. Carbon dioxide was bubbled through the solution until the pH of the solution dropped to 11.5. Table 5 shows an average yield of 7.9 pounds of carbon dioxide per gallon of solution based on solid yield. It was calculated that one gallon of this caustic treatment solution would mitigate fifteen cubic feet of pure CO₂ gas. This process is practical for removing CO₂ from natural gas or for mitigating carbon dioxide from flue gases which will contain CO₂ levels up to 30% but more often under 20%.

TABLE 5
CO₂ Scrubbing Performance

| | | | | CO₂ | |
|---|---|---|---|---|---|
| Conc. | | | % wt/wt | removed/gallon | |
| CO₂ | Flow Rate | | (NaOH/KOH) | (lbs.) | Comments |
| 100% | 1 | L/min | 48% | | Turns to |
| | | | | | solid - |
| | | | | | Highly |
| | | | | | exothermic |
| 100% | 0.75 | L/min | 36% | | Solids |
| | | | | | formed |
| | | | | | almost |
| | | | | | immediately |
| 100% | 0.75 | L/min | 36%* | | Solids |
| | | | | | formed |
| | | | | | slowly |
| 100% | 0.75 | L/min | 28%* | 7.9 | No solids |

*The solution contained less than 0.005% wt/wt natural organic chelating agent and 0.01% wt/wt EDTA. The solid formed is sodium carbonate or potassium carbonate.

If the NaOH and/or KOH is too concentrated, solids form when reacted with high concentrations of CO₂, and a high density solution of 1.5 g/mL or more lead to heterogenous flow regimes that resulted in CO₂ slippage. Table 5 shows the result of solid formation when running carbon dioxide through highly concentrated caustic solution. Water was then added to get the density of solution below 1.5 g/mL. A low concentration of chelating agents (<0.1%) was added to reduce solid formation. Ethylenediaminetetraacetic acid (EDTA) is a known chelating agent but also works as a weak scavenger for carbon dioxide.

Natural gas contains other impurities that can affect the purity of the products. This process is not for high sulfide containing gases. The stripping solution was tested on a natural gas stream and found to have less than 1% (wt/vol) organic compounds as impurities from the gas including propane, benzene, and toluene. Since the brine contains some of the residual organics, its use is appropriate for preparing ten pound brine (or other desired salinity) for enhanced oil recovery. Preparing the brine solution can include removal of volatiles and/or dilution with water. The brine product may be gently heated and the volatile organic compounds (VOCs) that volatilize can be captured on activated carbon, or the brine solution may be run through a column of activated carbon to adsorb organic impurities. One nonlimiting example of enhanced oil recovery is low salinity waterflooding. Brine solution with few organic impurities may have other uses such as road salt.

It should be noted that the embodiments are not limited in their application or use to the details of construction and steps described herein. Features of the illustrative embodiments, constructions, and variants may be implemented or incorporated in other embodiments, constructions, variants, and modifications, and may be practiced or carried out in various ways. Furthermore, unless otherwise indicated, the terms and expressions employed herein have been chosen for the purpose of describing the illustrative embodiments of the present invention for the convenience of the reader and are not for the purpose of limiting the invention. In short, it is the Applicants' intention that the scope of any patent issuing based on this disclosure be limited only by the scope of the appended claims.

What is claimed is:

1. A method of precipitating carbon dioxide stripped from natural gas or a post-combustion source, the method comprising:
providing an aqueous spent caustic solution comprising carbon dioxide;
adding calcium chloride and calcium hydroxide to precipitate calcium carbonate and form a brine solution.

2. The method of claim 1, wherein the brine solution has a pH in a range of 5.5 to 7.5.

3. The method of claim 1, wherein adding the calcium chloride comprising determining the molar concentration of the caustic solution and introducing half as much calcium chloride.

4. The method of claim 1, wherein the calcium hydroxide comprises about 0.2% to about 0.8% of the total calcium concentration.

5. The method of claim 4, wherein the calcium hydroxide comprises about 0.3% to about 0.6% of the total calcium concentration.

6. The method of claim 1, further comprising adding water before adding the calcium chloride and calcium hydroxide in an amount sufficient to solubilize precipitated sodium carbonate present in the aqueous caustic solution.

7. The method of claim 1, wherein the aqueous spent caustic solution comprises a pH in a range of 10.3 to 11.5.

8. The method of claim 1, further comprising collecting the calcium carbonate precipitate.

9. The method of claim 8, further comprising washing the calcium carbonate precipitate.

10. The method of claim 9, further comprising drying the calcium carbonate precipitate.

11. The method of claim 1, further comprising separating the calcium carbonate precipitate from the brine solution.

12. The method of claim 11, further comprising removing residual volatile organic compounds from the brine solution.

13. The method of claim 11, further comprising applying the brine solution to a roadway.

14. The method of claim 11, further comprising diluting the brine solution with water and dispensing the same for enhanced oil recovery.

15. The method of claim 1 further comprising:
providing a caustic treatment composition comprising:
about 25% to about 33% wt/wt of a strong base;
less than 0.1% wt/wt chelating agent; and
balance water;
wherein the caustic treatment composition has a density less than 1.5 g/ml and a pH greater than 11.5;
sparging a source gas comprising carbon dioxide through the caustic treatment composition thereby forming the aqueous spent caustic solution comprising carbon dioxide.

16. The method of claim 15, wherein sparging occurs until the pH drops to 11.5.

17. The method of claim 15, wherein the strong base comprises sodium hydroxide and/or potassium hydroxide.

18. The method of claim 17, wherein the strong base comprises both sodium hydroxide and potassium hydroxide having a ratio of weight percent of about 1:1.

19. The method of claim 15, wherein the chelating agent comprises ethylenediaminetetraacetic acid or ethylenediamine present as less than 0.05% wt/wt of the caustic treatment composition.

20. The method of claim 15, wherein the chelating agent further comprises grape seed extract present as less than 0.005% wt/wt of the caustic treatment composition.
